(19) United States
(12) Patent Application Publication
(10) Pub. No.: US 2010/0083847 A1
(43) Pub. Date: Apr. 8, 2010

(54) Salad Spinning Assembly

(76) Inventor: Phillip Kirschbaum, Petaluma, CA (US)

Correspondence Address: Phillip Kirschbaun, P.O. BOX 331, Petaluma, CA, 94953, US

(21) Appl. No.: 12/287,030

(22) Filed: Oct. 6, 2008

(51) Int. Cl. A47J 43/04

(52) U.S. Cl. 99/485

(57) ABSTRACT

Salad spinning assembly with a top bowl, a bottom bowl, an inner salad holding top bowl, an inner salad holding bottom bowl, a water absorbing sponge member, a pair of sliding bowl locking members, two pairs of spin strings, a pair of pull handles and an upper bowl to lower bowl gasket. The inner bowls having a plurality of water releasing apertures. The inner bowls nest within the outer bowls so that there is a gap between them. Pull strings are attached to the central outer portion of each outer bowl. When a user fills the salad holding bowls with salad greens and then places them within the outer top and bottom bowls and locks the bowls together, the user can twist the strings and then proceed to pull and release the pull handles to create a bowl spinning effect forcing excess water droplets to be absorbed by the sponge.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of salad preparation tools and more specifically to a salad spinning assembly.

When a person prepares a fresh salad, it is necessary to wash the salad greens and then remove the remaining excess water from the greens.

This may be done by patting the greens with a water absorbing towel or by putting the greens in a salad spinner. Salad spinners have been available in the market for over twenty-five years as evidenced by John Doyel's U.S. Pat. No. 4,209,916 issued in Jul. 1, 1980. They typically work by rotating a handle located on the top cover of the spinner assembly which in turn causes planetary gears to engage and spin an internal perforated salad bowl. There is a gap between the inner salad bowl and the outer bowl so that when the inner bowl is spun, the excess water in the salad greens is forced to fly outwards where it congregates at the bottom of the outer bowl.

Although the current design of salad spinners is adequate, there is another novel way of spinning the inner bowl that is effective, fun and provides an excellent arm exercise. Additionally, the current design of salad spinners requires numerous gears which can be difficult to clean and relatively costly to manufacture. Finally, the use of the gears in the existing design takes up valuable space that could otherwise be used for spinning and/or storing salad greens.

### BRIEF SUMMARY OF THE INVENTION

The primary object of the invention is to provide a salad spinning assembly that removes excess water from salad greens.

Another object of the invention is to provide a salad spinning assembly that exercises the user's arms during use.

Another object of the invention is to provide a salad spinning assembly that allows the user to store a maximum amount of salad inside it.

Another object of the invention is to provide a salad spinning assembly that is constructed of relatively few parts and is easy to clean and economical to manufacture.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a salad spinning assembly comprising: a top bowl, a bottom bowl, an inner salad holding top bowl, an inner salad holding bottom bowl, a water absorbing sponge member, a pair of sliding bowl locking members, two pairs of spin strings, a pair of pull handles, a upper bowl to lower bowl gasket, said inner bowls having a plurality of water releasing apertures, said inner bowls nested within said outer bowls so that there is a gap between said inner bowls and said outer bowls, said water absorbing sponge member filling a portion of the said gap between said nested inner and outer bowls at the said bowls widest circumference, one said pair of pull strings attached to the central outer portion of said top bowl, one said pair of pull strings attached to the central outer portion of said bottom bowl, each said string of said spring pair placed approximately one and one half inches apart from each other, said string pairs each terminating in said pull handles, said upper and lower bowls removably attached to each other by said sliding bowl locking means, said upper and lower bowls having a similar perimeter diameter, and said perimeter of said bowls retaining said bowl gasket between said bowls so that no water leaks out of said bowls during use.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a side section view of the invention.

FIG. 3 is a top plan view of the invention with the locking members in the open position.

FIG. 4 is a top plan view of the invention with the locking members in the closed position.

FIG. 5 is a perspective view of a locking member.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

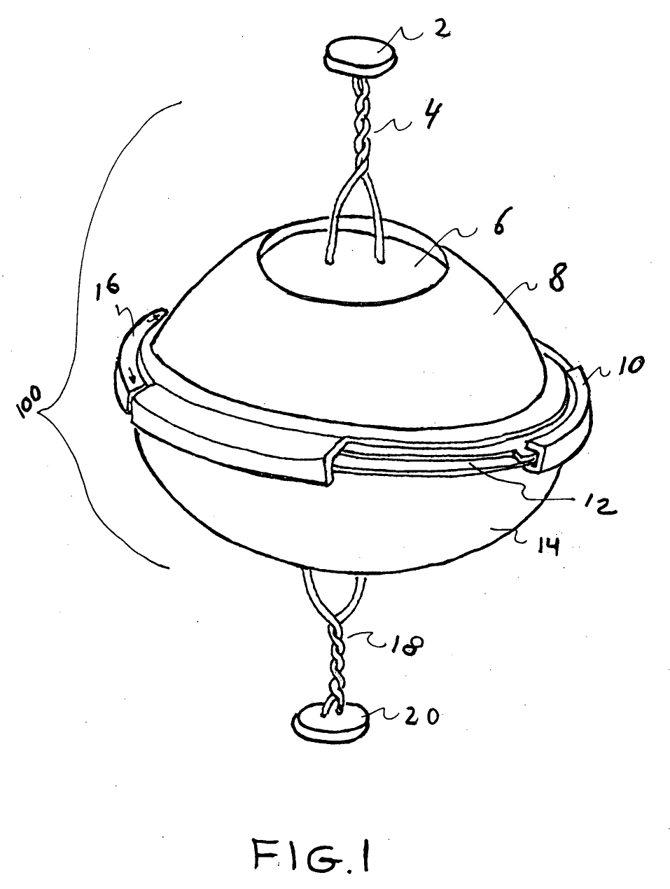

Referring now to FIG. 1 we see the salad spinning assembly 100 of the present invention. A top bowl 8 and a bottom bowl 14 are held together by sliding lock members 10, 16. A pair of strings 4 are centrally attached to the outer surface of the top bowl 8 and another pair of strings 18 are attached to the central outer portion of the bottom bowl 14. A pair of pull handles 2, 20 are attached to each pair of strings 4, 18. The user can hold the pull handles, 2, 20 one in each hand so that the salad bowl assembly 100 is in a horizontal orientation. He or she can then spin the strings and proceed to pull on the pull handles 2, 20 which will cause the salad bowl assembly 100 to spin in a similar fashion to a button spinning toy that has been a popular device for many years and can be seen on the Flickr Internet site at Flickr.com/photos/12368665@N061/sets.72157602389346904/. By pulling, then pausing, then pulling again on pull handles 2, 20, the user can maintain a spinning action of the bowl assembly 100. Because the bowls 8, 14 are identical in size and shape and weight, there is no imbalance when spinning the bowls. The pulling action is fun and is a great upper body workout. This method of salad spinning is a great way to engage children in the process of preparing food.

The user can open the bowls by sliding the locking members 10, 16 clockwise so that the locking members 10, 16 inhabit the cutout area 12,13 of the lip of bowl 8 thereby enabling the two bowls 8, 14 to be separated.

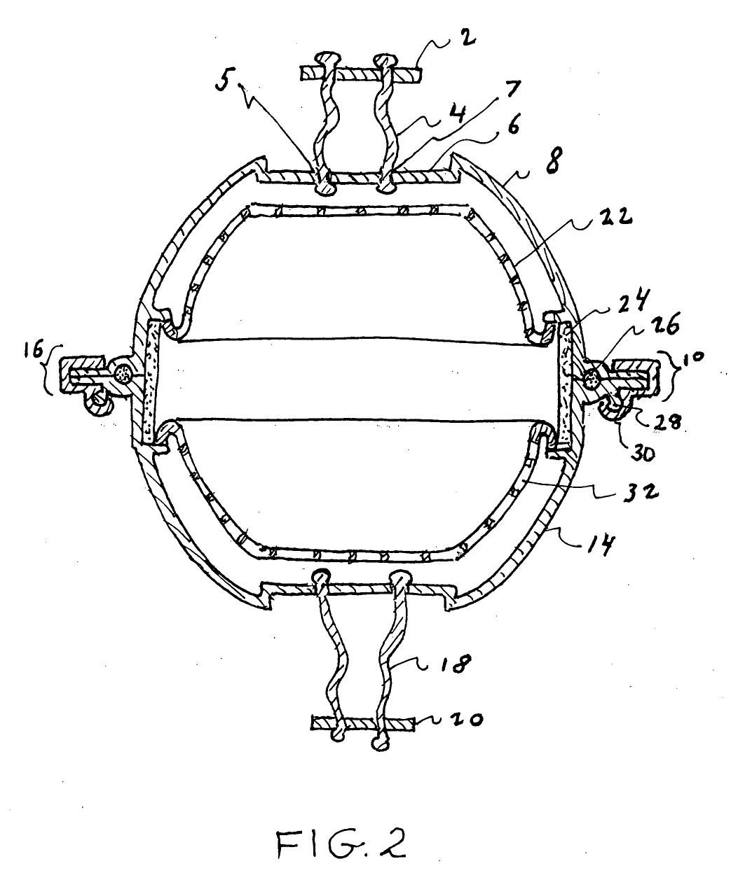

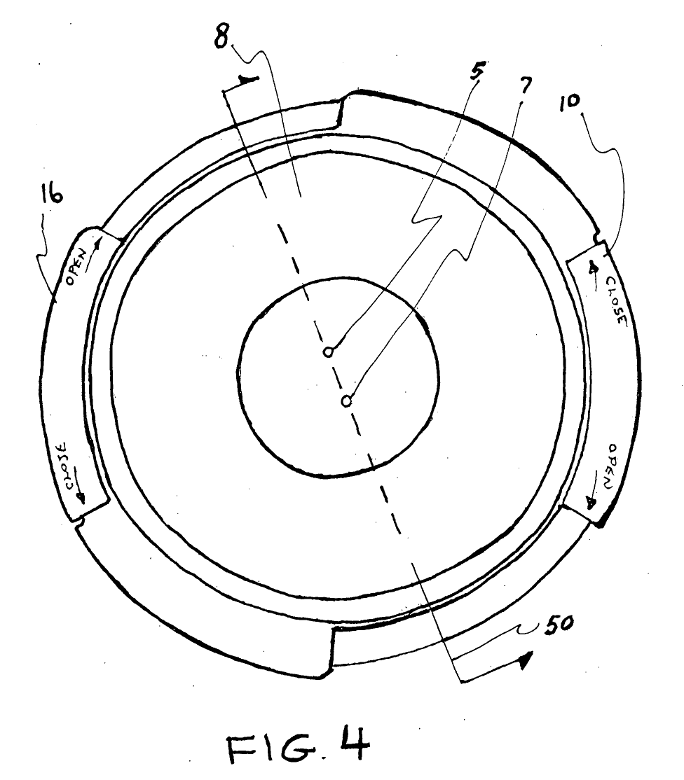

FIG. 2 is a side section view of the invention 100 as defined by section line 50 shown in FIG. 4. Inner bowls 22, 32 can retain salad greens. The bowls 22, 32 have a plurality of apertures 22 allowing excess water to migrate to the space between the inner bowls 22, 32 and the outer bowls 8, 14. When the bowls are spinning as described above, the excess water is forced to the outermost perimeter where water absorbing sponge member 24 is located. The sponge 24 can therefore absorb the excess water from the greens contained within. The sponge member 24 is cylindrical in shape and can be easily removed from the outer bowls 8, 14 for rinsing and cleaning. Gasket 26 forms a water tight seal between the perimeter faces of outer bowls 8, 14 so that when the user is spinning the device 100, no unwanted water can be released to the outer environment. The ideal distance between string pair members 4 is one and one half inches. The same is true with string pair members 18. The ideal length of spring pair members 4, 18 is approximately six inches.

Locking members 10, 16 have an under carriage 30 that slides on rail 28 so that even when the locking members 10, 16 are slid to the open position, they are still retained on the lip of bottom bowl 14.

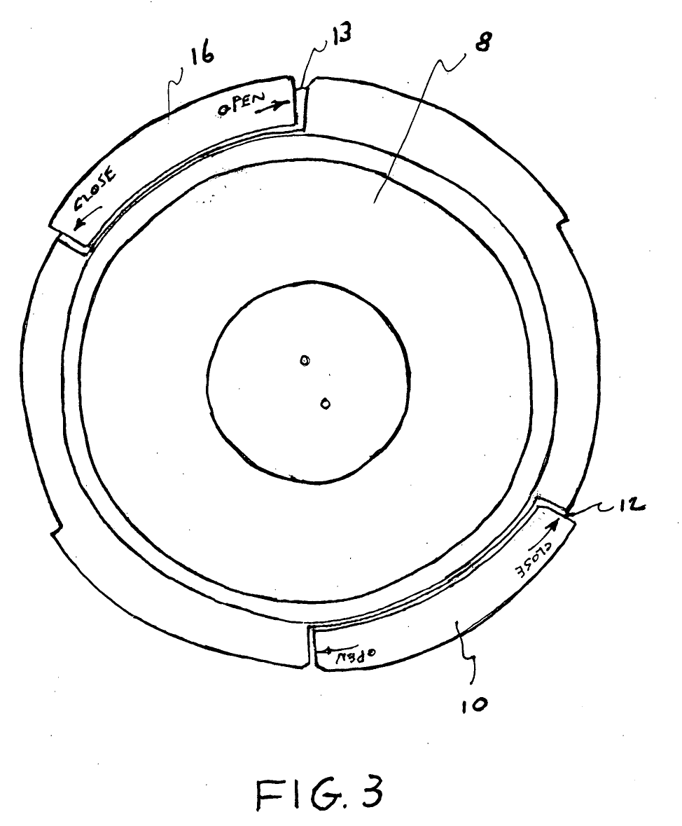

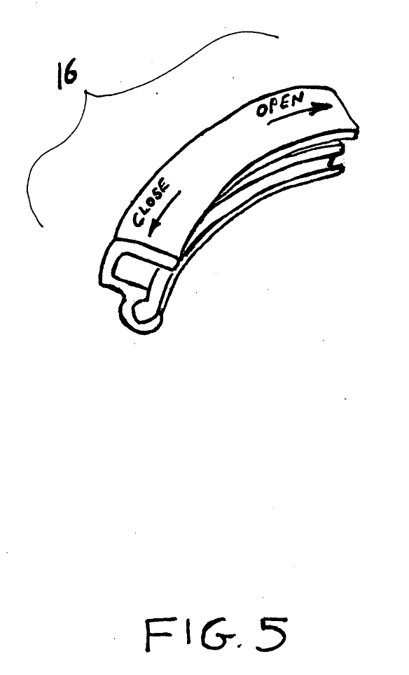

FIG. 3 shows a top plan view of the top bowl with the locking members 10, 16 in the open position where they reside in the cut away portion 12, 13 so that the top bowl 8 can be separated from the bottom bowl 14. FIG. 4 shows the same plan view of the top bowl 8 with the locking members 10, 16 in the closed position where the top bowl 8 and the bottom bowl 14 are forced together. FIG. 5 is a perspective view of locking member 16 for further clarification.

The above described and illustrated salad bowl spinner assembly is a novel and fun way to remove excess water from salad greens. The entire assembly is easy and economical to manufacture the space within the assembly allows for ample storage of salad when not being used as a water removing tool. The simplicity of the design makes it easy to clean and the nesting qualities of the bowls allows it to pack and store in a relatively compact space.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. salad spinning assembly comprising:
a top bowl;
a bottom bowl;
an inner salad holding top bowl;
an inner salad holding bottom bowl;
a water absorbing sponge member;
a pair of sliding bowl locking members;
two pairs of spin strings;
a pair of pull handles;
an upper bowl to lower bowl gasket;
said top bowl and said inner top bowl placed upside down on said bottom bowl and said inner bottom bowl;
said inner bowls having a plurality of water releasing apertures;
said inner bowls nested within said outer bowls so that there is a gap between said inner bowls and said outer bowls;
said water absorbing sponge member filling a portion of the said gap between said nested inner and outer bowls at the said bowls widest circumference;
one said pair of pull strings attached to the central outer portion of said top bowl;
one said pair of pull strings attached to the central outer portion of said bottom bowl;
each said string of said spring pair placed approximately one and one half inches apart from each other;
said string pairs each terminating in said pull handles;
said upper and lower bowls removably attached to each other by said sliding bowl locking means;
said upper and lower bowls having a similar perimeter diameter; and
said perimeter of said bowls retaining said bowl gasket between said bowls so that no water leaks out of said bowls during use.

2. Salad spinning assembly as claimed in claim 1 wherein when a user fills said salad holding bowls with salad greens and then places them within said top and bottom bowls and locks said bowls together, the user can twist said spin said string pairs by holding onto said pull handles and then proceeding to pull and release said pull handles in a rhythmic fashion to create a bowl spinning effect thereby forcing water droplets found on the enclosed salad greens to fly outward and be absorbed by said water absorbing sponge member.
